(19) United States
(12) Patent Application Publication
(10) Pub. No.: US 2024/0213570 A1
(43) Pub. Date: Jun. 27, 2024

(54) COOLING FIN USING PHASE CHANGE MATERIAL AND BATTERY MODULE INCLUDING THE SAME

(71) Applicant: HYUNDAI MOBIS CO., LTD., Seoul (KR)

(72) Inventor: Kihoon AHN, Yongin-si (KR)

(73) Assignee: HYUNDAI MOBIS CO., LTD., Seoul (KR)

(21) Appl. No.: 18/383,168

(22) Filed: Oct. 24, 2023

(30) Foreign Application Priority Data
Dec. 21, 2022 (KR) 10-2022-0180381

(51) Int. Cl. H01M 10/6551; H01M 10/613; H01M 10/6556; H01M 10/6569

(52) U.S. Cl. CPC H01M 10/6551; H01M 10/613; H01M 10/6556; H01M 10/6569

(57) ABSTRACT

The present disclosure relates to heat transfer means for cooling a battery module more efficiently. A cooling fin using phase change material and a battery module including the same of the present disclosure can improve cooling performance by stacking an aluminum cooling fin (PCM cooling fin) in which a phase change material is filled in an internal hollow part between battery cells. In addition, by extending the aluminum cooling fin filled with the phase change material to the outside of the battery cell, there is an effect of increasing heat dissipation performance and finally improving cooling performance.

### CROSS-REFERENCE TO RELATED APPLICATIONS

This application claims priority under 35 U.S.C. § 119 to Korean Patent Application No. 10-2022-0180381, filed on Dec. 21, 2022, in the Korean Intellectual Property Office, the disclosure of which is incorporated herein by reference in its entirety.

### TECHNICAL FIELD

The following disclosure relates to heat transfer means for cooling a battery module more efficiently.

### BACKGROUND

Secondary batteries, which are highly applicable to each product group and have electrical characteristics such as high energy density, are commonly applied not only to portable devices but also to electric or hybrid vehicles driven by an electrical driving source, power storage devices, and the like. These secondary batteries are attracting attention as a new energy source for improving eco-friendliness and energy efficiency that they do not generate any by-products due to the use of energy as well as the primary advantage of dramatically reducing the use of fossil fuels.

In this case, medium-large-sized devices such as automobiles require high power and large capacity, and a medium-large-sized battery module electrically connecting a plurality of battery cells is used. Since it is preferable that medium-large-sized battery modules are manufactured in a small size and weight as much as possible, prismatic batteries, pouch-type batteries, etc., which may be stacked with a high degree of integration and have a small weight-to-capacity ratio, have been mainly used as battery cells of medium-large-sized battery modules. Meanwhile, in order to protect a cell stack from external shock, heat, or vibration, the battery module may include a frame member having open front and rear surfaces for accommodating the battery cell stack in an internal space.

In this case, in order to support the battery cell stack, a number of parts including the frame member are applied to an upper portion of the battery cell stack, making it difficult to apply a structure for cooling the entire battery cell stack. Accordingly, in the prior art, since only a lower portion of the battery cell was cooled, the efficiency in controlling the temperature of the battery cell was very low.

In addition, as a plurality of battery cells are stacked, when the temperature of one battery cell rises above a certain level, nearby battery cells are affected and thermal runaway occurs. Due to the frame member protecting the battery cell stack, the internal pressure increases during the thermal runaway, so the battery cell stack exploded. However, the related art has a problem in that stability against this phenomenon is very low.

In the related art, the water cooling or air cooling method is applied to battery modules to prevent the thermal runaway of the battery cell stack, and a liquid immersion cooling method is applied only to high-performance electric vehicles. However, air mobility, which requires a larger capacity than this, requires 2 to 3 times higher output than electric vehicles, resulting in an increase in a heating value. In addition, the liquid immersion cooling method, which has strengths in cooling performance, also had a problem in that it was difficult to apply due to the problem of increasing weight.

### RELATED ART DOCUMENT

### Patent Document

(Patent Document 1) Japanese Patent Publication No. 5490241 “Battery module including a heat dissipation member having a novel structure and medium or large battery pack” (Mar. 7, 2014)

### SUMMARY

An embodiment of the present disclosure is directed to providing a cooling fin using phase change material capable of improving cooling performance by stacking an aluminum cooling fin (PCM cooling fin) having a phase change material filled in a hollow part therein between battery cells, and a battery module including the same.

In addition, the present disclosure provides a cooling fin using phase change material capable of improving heat dissipation performance and finally cooling performance by extending an aluminum cooling fin filled with a phase change material to the outside of a battery cell, and a battery module including the same.

In one general aspect, a cooling fin using a phase change material, which is a heat transfer means for contacting a heat source to absorb heat from the heat source and exchanging heat directly or indirectly with a cooling means, includes: a case having one surface in contact with the heat source and having a hollow part therein; a cooling material filled in the hollow part, in which the cooling material includes a phase change material having a heat transfer coefficient greater than or equal to a predetermined value at a predetermined temperature.

The case may include aluminum, and the cooling material may include a paraffin-based material.

The case may have a rectangular parallelepiped shape in which the cooling material is filled.

When a thickness direction perpendicular to one surface of the case is referred to as a first direction, and a longitudinal direction of the cooling fin perpendicular to the first direction is referred to as a second direction, a thickness of the case in the first direction at a predetermined position in the second direction may be greater than 0.1 times and less than or equal to 0.5 times a width of the hollow part in the first direction.

The case may include at least one support step protruding inward by a predetermined depth from a surface in contact with the heat source.

In the case, thicknesses of each edge may be thicker than that of one side other than the edge.

In another general aspect, a battery module to which a cooling fin using a phase change material is applied includes: a cooling fin using a phase change material; at least one battery cell cooled by contacting one surface with the cooling fin using a phase change material; and a cooling channel coupled to one end of the battery cell in a direction perpendicular to one surface of the battery cell, receiving heat from the cooling fin using a phase change material, and dissipating the heat to the outside.

The battery module may further include a gap filler interposed between the battery cell and the cooling channel and having a thermal conductivity higher than or equal to a predetermined value.

One surface of the cooling fin using a phase change material may extend toward the gap filler by a predetermined interval, and the gap filler may include a sealing part fixing the cooling fin using a phase change material.

One surface of the cooling fin using a phase change material may extend in a lateral direction of the battery cell by a predetermined interval, and the cooling channel or the gap filler may extend in an extension direction of the cooling fin using a phase change material by the same interval.

One surface of the cooling fin using a phase change material may extend to one side and the other side of the battery cell, the cooling channel or the gap filler may be coupled to both one end and the other end of the battery cell, and each of the gap fillers may include a sealing part between the battery cells.

The battery module may further include a surface pressure pad interposed between the cooling fin using a phase change material, reducing the pressure applied from the battery cell, and having a thermal conductivity greater than or equal to a predetermined value.

### BRIEF DESCRIPTION OF THE DRAWINGS

FIG. 1 is a partial schematic diagram of a battery module of the present disclosure.

FIG. 2 is a partial schematic diagram illustrating an embodiment of a battery module of the present disclosure.

FIG. 3 is a cross-sectional view of a cooling fin using a phase change material of the present disclosure.

FIG. 4 is a graph illustrating a change in temperature during rapid charging of a battery module including a cooling fin using a phase change material of the present disclosure.

FIG. 5 is a cross-sectional view of the cooling fin using a phase change material of the present disclosure.

FIG. 6 is a cross-sectional view of a cooling fin using a phase change material according to a first embodiment of the present disclosure.

FIG. 7 is a cross-sectional view illustrating a cooling fin using a phase change material according to a second embodiment of the present disclosure.

FIG. 8 is a cross-sectional view illustrating a cooling fin using a phase change material according to a third embodiment of the present disclosure.

FIG. 9 is a cross-sectional view of a cooling fin using a phase change material of a fourth embodiment of the present disclosure.

FIG. 10 is a cross-sectional view illustrating a battery module including a surface pressure pad of the present disclosure.

### DETAILED DESCRIPTION OF MAIN ELEMENTS

1000: Battery module
100: Cooling fin using phase change material
110: Case
111: Hollow part
112: Support step
120: Cooling material
200: Battery cell
300: Cooling channel
400: Gap filler
410: Sealing part
500: Surface pressure pad

### DETAILED DESCRIPTION OF EMBODIMENTS

Hereinafter, the technical spirit of the present disclosure will be described in more detail with reference to the accompanying drawings. Terms and words used in the present specification and claims are not to be construed as a general or dictionary meaning, but are to be construed as meaning and concepts meeting the technical ideas of the present disclosure based on a principle that the present inventors may appropriately define the concepts of terms in order to describe their inventions in best mode.

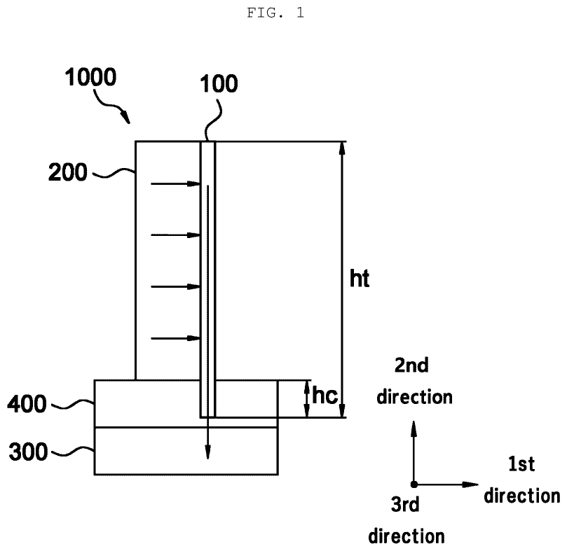

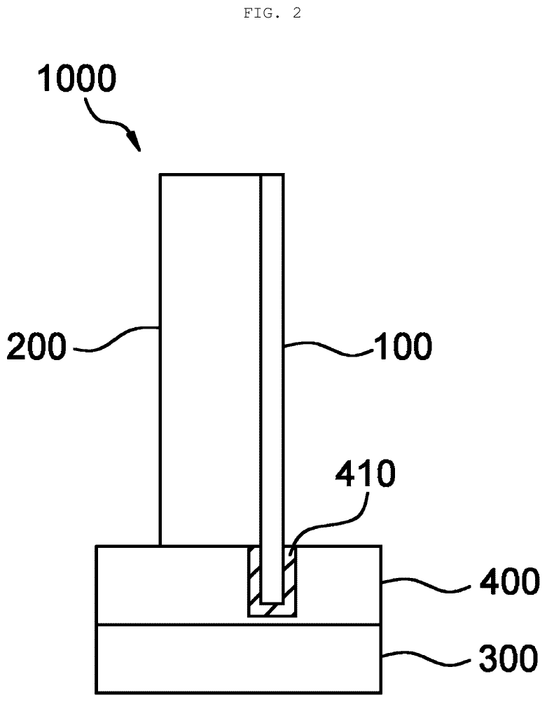

Hereinafter, a basic configuration of a battery module 1000 of the present disclosure will be described with reference to FIGS. 1 and 2.

As illustrated in FIG. 1, in a battery module to which a cooling fin 100 using a phase change material is applied, the present disclosure may include at least one battery cell 200 stacked in a thickness direction (first direction in FIG. 1). The cooling fin 100 using a phase change material may be stacked between each battery cell 200 to cool the battery cell 200. In FIG. 1, some components are omitted to illustrate the coupling relationship, and in an actual use example, the cooling fin 100 using a phase change material to which phase change material may be applied to both surfaces of all battery cells 200 except for the battery cells 200 at both ends to cool both surfaces.

In addition, the battery module 1000 of the present disclosure may include a cooling channel 300 in which a plane perpendicular to one surface of the battery cell 200, that is, a plane perpendicular to a second direction of FIG. 1 is coupled to one end of the battery cell 200. As illustrated in FIG. 1, the cooling channel may be a stack having a predetermined area and thickness, or may be a cooling pipe disposed on a plane perpendicular to the second direction. By including the cooling channel, the battery module 1000 of the present disclosure may transfer the heat of the battery cell 200 absorbed by the cooling fin 100 using a phase change material to the cooling channel 300 disposed outside the battery module 1000 and then dissipate the heat to the outside of the battery module.

In addition, the battery module 1000 of the present disclosure may include a gap filler 400 interposed between the battery cell 200 and the cooling channel and having a thermal conductivity greater than or equal to a predetermined value. In this case, the gap filler 400 may be a thermal interface material (TIM), and may reduce contact thermal resistance with the battery cell 200, and at the same time, secure insulation of the battery module 1000. In addition, the thermal conductivity of the gap filler 400 may be 2.5 W/mk to 3.5 W/mk. By including the gap filler 400, it is possible to protect the cooling channel and the outer housing from the pressure generated on the side of the battery cell 200, and secure a heat transfer path between the cooling channel 300, the battery cell 200, and the cooling fin 100 using a phase change material.

One end of the cooling fin 100 using a phase change material may extend toward the gap filler 400 to be coupled with the gap filler 400, and a height h_{c} of the cooling fin 100 using a phase change material in the second direction at which the cooling fin 100 using a phase change material is inserted into the gap filler 400 may be 5% or more of a maximum height hₜ of the cooling fin 100 using a phase change material in the second direction.

In addition, as illustrated in FIG. 2, one end of the cooling fin 100 using a phase change material may extend toward the gap filler 400 to be coupled with the gap filler 400. A sealing part 410 may be included between the gap filler 400 and the cooling fin 100 using a phase change material, and the sealing part 410 may seal the cooling fin 100 using a phase change material so that the cooling material 120 of the cooling fin 100 using a phase change material does not leak to the outside.

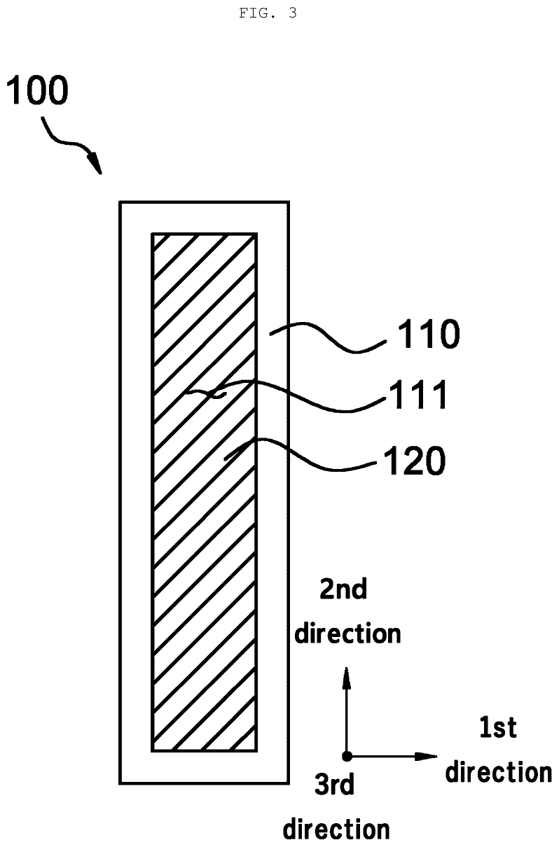

Hereinafter, the basic form of the cooling fin 100 using a phase change material according to the present disclosure will be described with reference to FIGS. 3 to 5.

As illustrated in FIG. 3, the cooling fin 100 using a phase change material of the present disclosure may serve as a heat transfer means for absorbing heat from a heat source (=battery cell 200 of the present disclosure) in contact with a heat source and exchanging heat directly or indirectly with a cooling means (=cooling channel 300 of the present disclosure). The cooling fin 100 using a phase change material of the present disclosure may include a case 110 and a cooling material 120 filled in the case 110. In more detail, the case 110 may have one surface in contact with the heat source and may have a hollow part 111 therein. In addition, the cooling material 120 may be filled in the hollow part 111 of the case 110, and preferably includes a phase change material (Phase Change Material) having a heat transfer coefficient greater than or equal to a predetermined value at a predetermined temperature.

In this case, the case 110 is preferably configured to include aluminum. By applying the aluminum case 110, it is possible to secure rigidity and have an effective heat transfer structure with a cooling block. The cooling material 120 preferably includes a paraffin-based material. In this case, the phase change temperature of the cooling material 120 may be higher than or equal to 20° C. and lower than 46° C. By designating the phase change temperature standard within this range, the temperature of the battery module 1000 may be maintained at 50° or lower which is an upper limit of temperature of a commercially available fast charging battery.

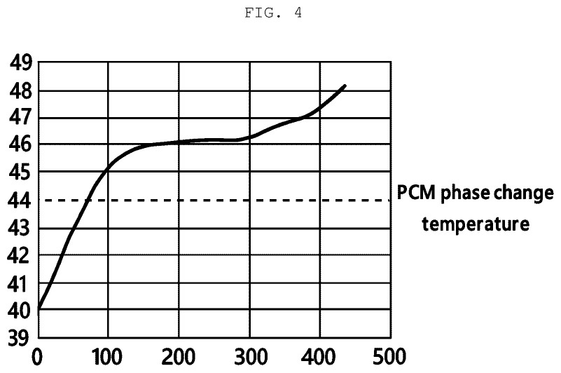

The phase change material included in the cooling material 120 may absorb/release a large amount of thermal energy in the form of latent heat during the phase change process, and instantly absorb heat from the battery cell 200 using these characteristics. Accordingly, the cooling efficiency of the battery module 1000 may be finally maximized. As the cooling fin 100 using a phase change material is applied, as illustrated in FIG. 4, in the battery module 1000 of the present disclosure, it can be confirmed that the temperature rise is lowered starting from the phase change temperature of the phase change material included in the cooling material 120.

In addition, the case 110 of the cooling fin 100 using a phase change material may have a rectangular parallelepiped shape in which the cooling material 120 is filled therein. In addition, one surface (a surface perpendicular to the first direction in FIG. 2) contacting one surface of the battery cell 200 may be formed to correspond to the shape of the battery cell 200.

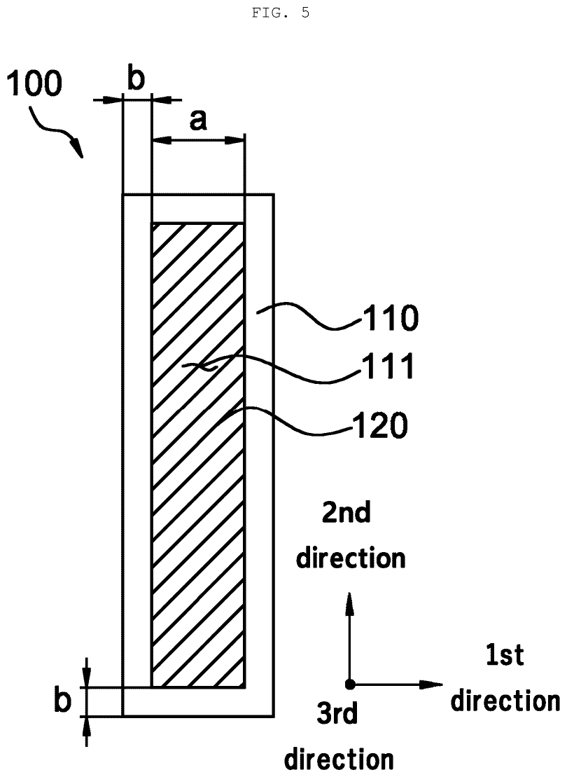

In more detail, as illustrated in FIG. 5, when a thickness direction perpendicular to one surface of the case 110 is referred to as a first direction, and a longitudinal direction of the cooling fin 100 using a phase change material perpendicular to the first direction is referred to as a second direction, it is preferable that the thickness of the case 110 in the first direction at a predetermined position in the second direction is preferably greater than 0.1 times and less than equal to 0.5 times the width of the hollow part 111 in the first direction. In this case, the total thickness of the case 110 in the first direction may be greater than 0 mm and less than or equal to 2 mm, so the case 110 may be easily interposed between the battery cells 200. The case 110 can be easily processed into a detailed structure as described above by including aluminum.

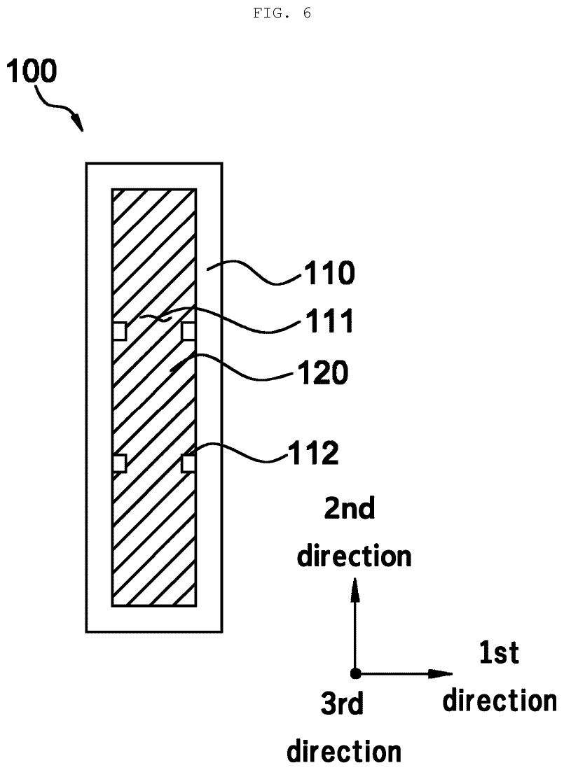

Hereinafter, a first embodiment of the cooling fin 100 using a phase change material according to the present disclosure will be described with reference to FIG. 6.

As illustrated in FIG. 6, the case 110 may include at least one support step 112 protruding inward by a predetermined depth from a surface in contact with the battery cell 200. In this case, the support step 112 may be formed concentrated in the center of one surface, and may be formed spaced apart from each other at regular intervals. A protruding height of the support step 112 may be formed shorter than a cross-sectional area of the support step 112. In addition, in addition to the shape formed in FIG. 4, the case 110 is destroyed by battery swelling that occurs in a center of the battery cell 200 according to an inner center of one surface of the case 110 having a certain height, so it is possible to prevent the cooling material 120 from leaking to the outside.

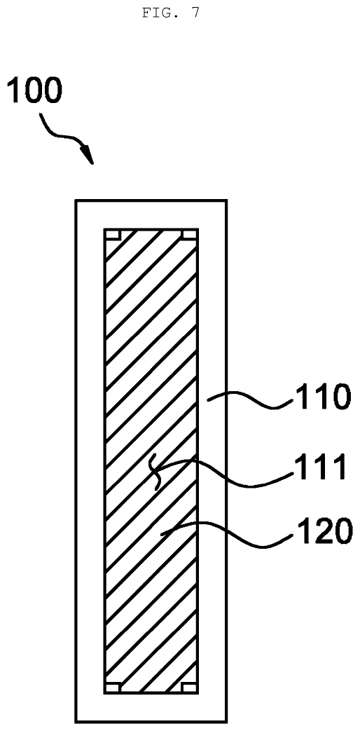

Hereinafter, a second embodiment of the cooling fin 100 using a phase change material according to the present disclosure will be described with reference to FIG. 7.

As illustrated in FIG. 7, the case 110 may extend so that thicknesses of each edge are thicker than a thickness of one surface other than the edge. Alternatively, a member for sealing may be added to the inner edge or the outer edge, or a coating layer may be stacked. Accordingly, when a certain or more pressure is applied to one surface and the other surface of the case 110 due to the swelling phenomenon of the battery cell 200, the case 110 does not burst and the cooling material 120 may be accommodated in the hollow part 111 more stably. Accordingly, the stability can be increased.

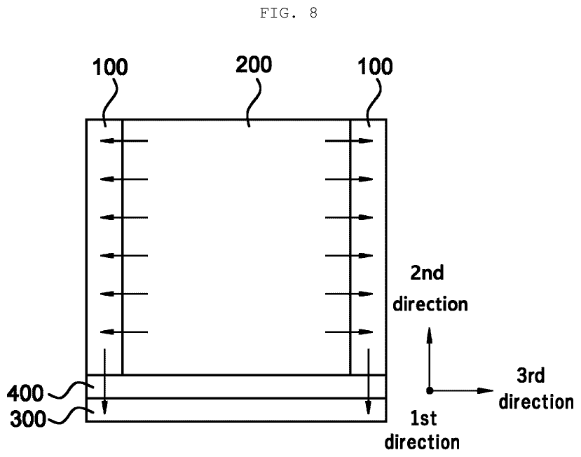

Hereinafter, a third embodiment of the cooling fin 100 using a phase change material according to the present disclosure will be described with reference to FIG. 8.

As illustrated in FIG. 8, one surface of the cooling fin 100 using a phase change material may extend in a lateral direction of the battery cell 200, that is, in the third direction of FIG. 8 by a predetermined interval. For example, it may be formed to extend in both directions based on the battery cell 200. In this case, the cooling channel 300 or the gap filler 400 may extend by the same interval in the extending direction of the cooling fin 100 using a phase change material. Accordingly, heat generated by the battery cell 200 is absorbed in an area where the battery cell 200 and the cooling fin 100 using a phase change material contact each other, and the absorbed heat may be transferred along the direction in which the cooling fin 100 using a phase change material extends. The transferred heat may be dissipated to the outside of the battery module 1000 along the gap filler 400 and the cooling channel 300. Accordingly, the battery cell 200 continuously generating heat and the heat transfer path may be separated, so it is possible to maximize the heat dissipation effect.

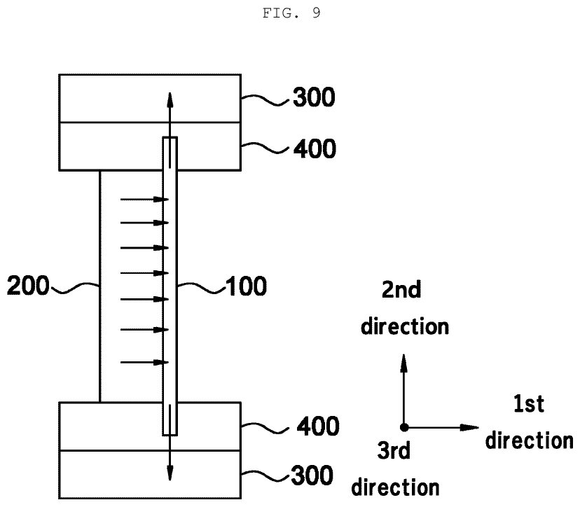

Hereinafter, a fourth embodiment of the cooling fin 100 using a phase change material according to the present disclosure will be described with reference to FIG. 9.

As illustrated in FIG. 9, one surface of the cooling fin 100 using a phase change material may extend to one side and the other side of the battery cell 200. In this case, the cooling channel 300 or the gap filler 400 may be coupled to both one end and the other end of the battery cell 200, and the cooling fin 100 using a phase change material may be supported extending to the inside of the gap filler 400. In this case, each gap filler 400 may include a sealing part 410 between the battery cells 200. Alternatively, the cooling fin 100 using a phase change material is extended to both one side and the other side of the battery cell 200, but the cooling channel 300 or the gap filler 400 is disposed only on one end of the battery cell 200, and the other end of the battery cell 200 may be open, or an external cooler may be provided separately. Accordingly, it is possible to transfer heat to both one end and the other end of the battery cell 200 to be dissipated, separate the battery cell 200 continuously generating heat and the heat transfer path, and maximize the heat dissipation effect.

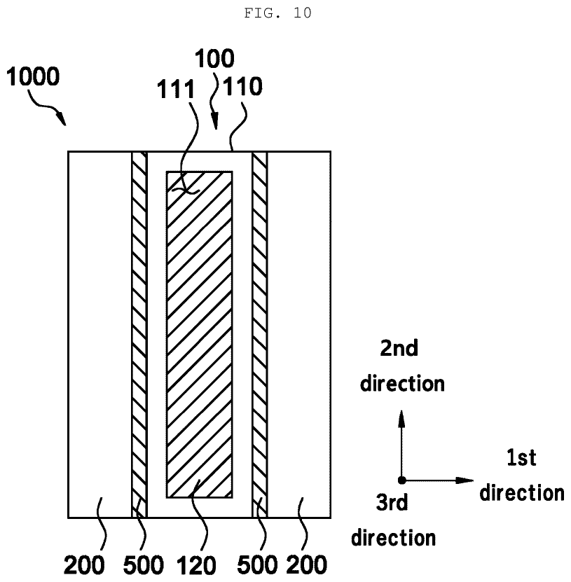

Hereinafter, other embodiments of the battery module 1000 according to the present disclosure will be described with reference to FIG. 10.

As illustrated in FIG. 10, a surface pressure pad 500 interposed between the cooling fin 100 using a phase change material and the battery cell 200 may be further included. The surface pressure pad 500 may reduce the pressure applied from the battery cell 200 and maintain a heat transfer rate by having thermal conductivity greater than or equal to a predetermined value. By including the surface pressure pad 500, it is possible to reduce the load applied to the cooling fin 100 using a phase change material from external impact and swelling, and prevent the cooling material 120 filled inside the cooling fin 100 using a phase change material 120 from leaking to the outside.

According to the configuration described above, a cooling fin using a phase change material and a battery module including the same of the present disclosure may be cooled by stacking an aluminum cooling fin (PCM cooling fin) having a phase change material filled in an hollow part therein between battery cells, thereby improving performance.

In addition, by extending the aluminum cooling fin filled with the phase change material to the outside of the battery cell, it is possible to increase heat dissipation performance and finally improve cooling performance.

The present disclosure should not be construed to being limited to the above-mentioned exemplary embodiment. The present disclosure may be applied to various fields and may be variously modified by those skilled in the art without departing from the scope of the present disclosure claimed in the claims. Therefore, it is obvious to those skilled in the art that these alterations and modifications fall in the scope of the present disclosure.

What is claimed is:

1. A cooling fin using a phase change material, which is a heat transfer means for contacting a heat source to absorb heat from the heat source and exchanging heat directly or indirectly with a cooling means, the cooling fin comprising:
a case having one surface in contact with the heat source and having a hollow part therein; and
a cooling material filled in the hollow part,
wherein the cooling material includes a phase change material having a heat transfer coefficient greater than or equal to a predetermined value at a predetermined temperature.

2. The cooling fin of claim 1, wherein the case includes aluminum, and the cooling material includes a paraffin-based material.

3. The cooling fin of claim 1, wherein the case has a rectangular parallelepiped shape in which the cooling material is filled.

4. The cooling fin of claim 3 wherein, when a thickness direction perpendicular to the one surface of the case is referred to as a first direction, and a longitudinal direction of the cooling fin perpendicular to the first direction is referred to as a second direction, a thickness of the case in the first direction at a predetermined position in the second direction is greater than 0.1 times and less than or equal to 0.5 times a width of the hollow part in the first direction.

5. The cooling fin of claim 3, wherein the case includes at least one support step protruding inwards by a predetermined depth from a surface in contact with the heat source.

6. The cooling fin of claim 5, wherein a thickness of the case at each edge portion thereof is greater than a thickness of the case at one side other than the edge portion.

7. A battery module to which a cooling fin using a phase change material is applied, the battery module comprising:
a cooling fin including a phase change material;
at least one battery cell having one surface in contact with the cooling fin so that the battery cell is cooled by the phase change material of the cooling fin; and
a cooling channel coupled to one end surface of the battery cell perpendicular to the one surface of the battery cell, receiving heat from the cooling fin including the phase change material, and dissipating the heat to an outside.

8. The battery module of claim 7, further comprising:
a gap filler interposed between the battery cell and the cooling channel and having a thermal conductivity higher than or equal to a predetermined value.

9. The battery module of claim 8, wherein the cooling fin including the phase change material extends toward the gap filler so that an end of the cooling fin is embedded in the gap filler by a predetermined interval, and
the gap filler includes a sealing part fixing the cooling fin including the phase change material.

10. The battery module of claim 9, wherein the cooling fin including the phase change material extends to the direction of perpendicular to one surface of the battery cell by a predetermined interval, and
the cooling channel or the gap filler extends in an extension direction of the cooling fin including the phase change material by the same interval of the cooling fin.

11. The battery module of claim 8, wherein the cooling fin including the phase change material extends to one side surface and an opposing side surface of the battery cell,
the cooling channel or the gap filler is coupled to both of the one end surface and an opposing end surface of the battery cell, and
each of the gap fillers includes a sealing part between the battery cells.

12. The battery module of claim 7, further comprising:
a surface pressure pad interposed between the cooling fin including the phase change material, but reducing the pressure applied from the battery cell and having a thermal conductivity greater than or equal to a predetermined value.
